(19) United States
(12) Patent Application Publication
(10) Pub. No.: US 2005/0275872 A1
(43) Pub. Date: Dec. 15, 2005

(54) Storage medium, printing method, and printing apparatus

(75) Inventor: Koichi Otsuki, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/612,871

(22) Filed: Jul. 7, 2003

(30) Foreign Application Priority Data
Jul. 8, 2002 (JP) 2002-198375
Jul. 2, 2003 (JP) 2003-190064

(51) Int. Cl. G06F 3/12; G06F 13/00; H04B 7/00

(52) U.S. Cl. 358/1.15; 455/41.3; 455/66.1; 358/1.16

(57) ABSTRACT

It is an object of the invention to provide a storage medium or the like with which printing can be carried out easily by performing predetermined processing with respect to image data, and which allows, prior to operations, visual confirmation of changes in an image caused by the processing. The storage medium that is used for performing predetermined processing with respect to image data for printing with a printing apparatus, and that is provided independent of the printing apparatus, comprises process information for performing the predetermined processing, and information for allowing visual confirmation of a change in an image that is caused by the processing.

### CROSS-REFERENCE TO RELATED APPLICATIONS

The present application claims priority upon Japanese Patent Application No. 2002-198375 filed on Jul. 8, 2002, and Japanese Patent Application No. 2003-190064 filed on Jul. 2, 2003, which are herein incorporated by reference.

### BACKGROUND OF THE INVENTION

1. Field of the Invention

The present invention relates to a storage medium used for performing predetermined processing with respect to image data for printing with a printing apparatus, and a printing method and a printing apparatus using such a storage medium.

2. Description of the Related Art

In recent years, the explosion in popularity of image input devices and the like such as personal computers and digital cameras has made it possible for users to freely print images such as photographs. Particularly, digital cameras are more simple than conventional silver halide photography and allow printing to be carried out easily with a printing apparatus such as a printer immediately after the images are captured, and therefore, they have become popular and widespread among all age groups and among men and women alike. Moreover, there is an increasing number of digital camera users who not only simply print out captured image data but also process the original image data by performing predetermined processing, such as intensifying the color red when printing image data of the setting sun or converting the entire image to the color sepia in order to change the mood of the image, in order to cater to their individual tastes using retouching software, for example, allowing original images to be enjoyed as pieces of art.

However, the task of performing predetermined processing with respect to the image data using such retouching software, for example, is extremely complicated for older persons or women, who generally are not familiar with operating technical devices. Moreover, to what extent and with what kind of processes the image data should be processed in order to obtain a desired image often depends on the experience of the user, so that, for example, producing a desired image in the manner in which one wishes is not an easy task for users, even if they are accustomed to operating computers. Furthermore, a user cannot predict how an image will turn out after it has been subjected to the process that he/she has set until an actual simulation is carried out, and thus, there is the problem that it was necessary for the task of adjusting the settings and performing simulations to be carried out repeatedly, and this had the potential to become extremely time consuming.

### SUMMARY OF THE INVENTION

It is an object of the invention to provide a storage medium with which printing can be carried out easily by performing predetermined processing with respect to image data and which allows changes in the image due to such processing to be visually confirmed in advance before operations, a printing method using such a storage medium, and a printing apparatus suited for printing using such a storage medium.

A main invention is a storage medium that is used for performing predetermined processing with respect to image data for printing with a printing apparatus, and that is provided independent of the printing apparatus, comprising: process information for performing the predetermined processing; and information for allowing visual confirmation of a change in an image that is caused by the processing.

Other features of the present invention will become clear by the descriptions in the present specification and the accompanying drawings.

### BRIEF DESCRIPTION OF THE DRAWINGS

For a more complete understanding of the present invention and the advantages thereof, reference is now made to the following description taken in conjunction with the accompanying drawings.

FIG. 1 is a diagram showing a schematic configuration of a printing apparatus according to the present embodiment.

FIG. 2 is a diagram that shows an internal configuration of a printer 2 and an internal configuration of a control circuit 50 according to this embodiment.

FIG. 3A is a plan perspective view showing a configuration of a memory card 9.

FIG. 3B is a block diagram for describing an internal configuration of the memory card 9 and a send/receive section 95.

FIG. 4 is an external view of an example of the memory card exterior.

FIG. 5 is an explanatory diagram showing the positional relationship between a slot of the printer and an antenna of this embodiment.

FIG. 6 is a diagram showing a state in which both the memory card and cartridges can be communicated with.

FIG. 7 is a diagram for illustrating a concept of the printing operation of the present invention.

FIG. 8 is a flowchart showing an overview of a normal printing process of the computer system according to this embodiment.

FIG. 9 is a flowchart showing an overview of the printing process of the computer system according to this embodiment when the memory card is used.

FIG. 10 is a cross-sectional diagram showing a laser printer that can be adopted as the printing apparatus of the present invention.

FIG. 11 is a schematic external view of a printer according to another embodiment.

### DETAILED DESCRIPTION OF PREFERRED EMBODIMENTS

At least the following matters will be made clear by the description in the present specification and the accompanying drawings.

A storage medium that is used for performing predetermined processing with respect to image data for printing with a printing apparatus, and that is provided independent of the printing apparatus, comprises:
process information for performing the predetermined processing; and information for allowing visual confirmation of a change in an image that is caused by the processing.

This storage medium allows a desired image to be easily and reliably printed because the image data is processed using the process information for carrying out the processing after the information allowing changes in the image caused by the predetermined processing to be visually confirmed has been checked.

In this storage medium, it is preferable that the information for allowing visual confirmation is shown on a surface of the storage medium.

With this storage medium, it is possible to identify changes in the image due to the stored process information simply by looking at the outside of the storage medium. Thus, the use of incorrect storage media can be prevented.

In this storage medium, the process information may be information for changing the color tone of the image to be printed.

With this storage medium, the color tone of the image to be printed can be changed easily.

In this storage medium, the change in color tone may be an emphasis of a specific color.

With this storage medium, it becomes possible to easily perform the processing for emphasizing a specific color in the image to be printed and carry out printing.

In this storage medium, the change in color tone may be color conversion from a color image to a monochrome image.

With this storage medium, it is easy to perform conversion to a monochrome image, even if the image data to be printed is data for a color image.

In this storage medium, it is also possible that the change in color tone is a color conversion from a color image to a sepia image.

With this storage medium, it is easy to perform conversion to a sepia image, even if the image data to be printed is data for a color image.

In this storage medium, it is preferable that the information for changing a color tone is a color conversion data table.

With this storage medium, the color tone can be changed easily based on the color conversion table that is stored.

In this storage medium, it is preferable that the process information is information for changing a size of an image to be printed.

With this storage medium, the size of an image to be printed can be changed easily.

In this storage medium, it is preferable that the information is for changing a resolution of an image to be printed.

With this storage medium, the resolution of the image to be printed can also be changed easily, and for example, if high image quality is not needed such as during test printing, an image with low resolution can be printed easily.

In this storage medium, it is preferable that the information for allowing visual confirmation is an example of an image printed without the processing being performed and an example of an image printed with the processing being performed.

With this storage medium, the user can confirm in advance the image that will be printed when using the process information stored in the storage medium by comparing the example of the image without the processing being performed and the example of the image with the processing being performed.

In this storage medium, it is preferable that the storage medium can communicate wirelessly with the printing apparatus.

With this storage medium, the process information for executing the predetermined processing can be supplied to the printing apparatus easily through non-contact communication, without having to provide a contact point for mechanical connection.

In this storage medium, it is preferable that the storage medium has a flat antenna.

With this storage medium, the storage medium can be made flat and compact.

It is also possible for the storage medium to include a contact point for connecting to the printing apparatus.

With this storage medium, the storage medium is brought into contact with the printing apparatus so that process information can be reliably transmitted.

Further, a storage medium that is used for performing predetermined processing with respect to image data for printing with a printing apparatus, and that is provided independent of the printing apparatus, comprises:
a color conversion data table for changing a color tone of an image to be printed in order to perform the processing;
information for allowing visual confirmation of a change in an image that is caused by the processing, wherein the information is an example of an image printed without the processing being performed and an example of an image printed with the processing being performed that are shown on a surface of the storage medium; and
a flat antenna that is capable of communicating wirelessly with the printing apparatus.

With this storage medium, process information to be used for predetermined processing can be supplied to a printing apparatus through non-contact communication, allowing a desired image to be printed without carrying out any particular settings or complex tasks for processing the image data. In particular, since the user can confirm changes in the image that will be caused by the processing, which are shown on the surface of the medium, prior to printing simply by looking at the storage medium, it is possible to prevent the printing of an image that has been processed incorrectly or that does not match the desired image.

Further, a printing method for performing predetermined processing with respect to image data for printing with a printing apparatus, comprises the following steps:
a step of setting, on the printing apparatus, a storage medium which is provided independent of the printing apparatus and in which process information for performing the predetermined processing is stored, and which has information for allowing visual confirmation of a change in an image that is caused by the predetermined processing;
a step of obtaining the process information;
a step of performing the predetermined processing with respect to the image data based on the process information that has been obtained; and
a step of printing based on the image data that has been subjected to the predetermined processing.

With this printing method, the user sets the storage medium on the printing apparatus after confirming changes in the image that is caused by the information of the storage medium, thus allowing desired processing to be carried out reliably. Also, simply by setting the storage medium on the printing apparatus, the image data can be subjected to desired processing and printing can be carried out easily.

Also, a printing apparatus capable of performing predetermined processing with respect to image data for printing, comprises:
a reader for reading information in a storage medium which is provided independent of the printing apparatus and in which process information for performing the predetermined processing is stored, and which has information for allowing visual confirmation of a change in an image that is caused by the predetermined processing; and
a processor for performing the predetermined processing based on the information that has been read out.

With this printing apparatus, a desired image to which predetermined processing has been carried out using the process information, which is for performing the predetermined processing and which is stored in the storage medium, can be printed.

===Schematic Configuration of Printing Apparatus===

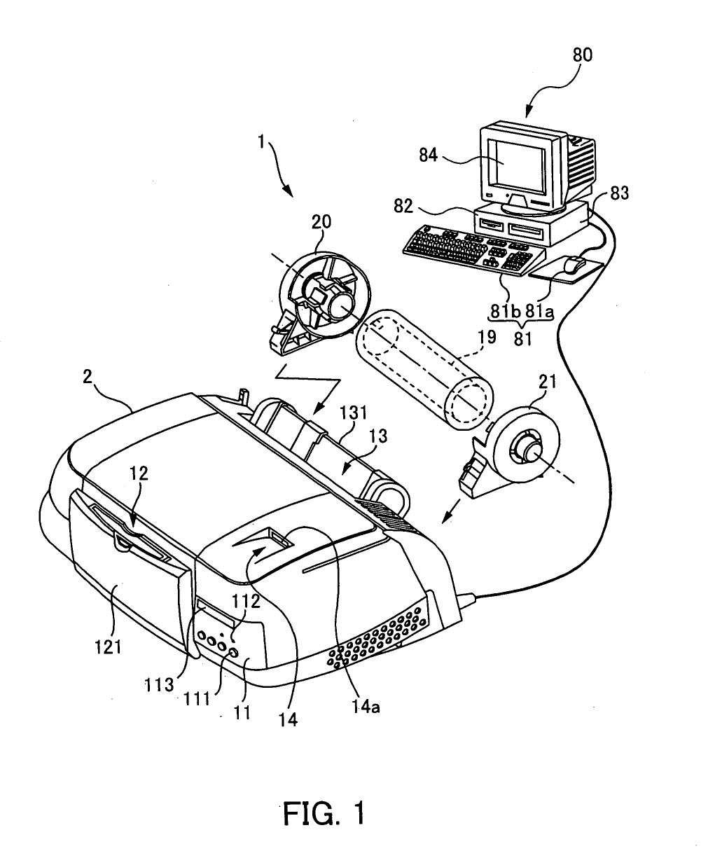

A schematic configuration primarily of the exterior of a printing apparatus according to this embodiment is described with reference to FIG. 1. FIG. 1 is a diagram showing the schematic configuration of the printing apparatus according to this embodiment.

FIG. 1 shows a computer system 1 serving as an example of a printing apparatus, in which a color inkjet printer 2 (hereinafter referred to as “printer”) and a host computer 80 are connected. The computer system 1 serving as the printing apparatus is made of the printer 2 and the host computer unit 80, which is provided with a main computer unit 83, a display 84, input devices 81 such as a mouse 81a and a keyboard 81b, and a reading device 82. It should be noted that the printer 2 has a roll paper unit 19 that is removably mounted thereto.

The printer 2 is capable of outputting color images, and is an inkjet-type printer that uses, for example, four colors of ink, such as cyan (C), magenta (M), yellow (Y), and black (K), as its recording agent. These color inks are ejected onto a medium to be printed, including but not limited to roll paper, so as to form images by forming dots. It should be noted that in addition to the above-mentioned four colors, it is also possible to use light cyan (pale cyan, LC), light magenta (pale magenta, LM) and dark yellow (dim yellow, DY) as the color inks.

As shown in FIG. 1, the printer 2 is provided with a paper supply section 13 on its rear side, and is configured such that a medium to be printed, such as print paper, that is supplied from this paper supply section is ejected from its front side. A control panel 11 and a paper discharge section 12 are provided on the front side of the printer 2, and a slot 14 onto which a memory card 9, which is a storage medium, is mounted from the outside is provided in an upper portion of the printer 2.

The control panel 11 is provided with various types of control buttons 111, and display lamps 112 and a display screen 113 for supplying various types of information to the user. Also, the paper discharge section 12 is provided with a paper discharge tray 121 that blocks the paper discharge opening when the printer is not in use, and the paper feed portion 13 is provided with a paper supply holder 131 for holding cut paper (not shown) and roll paper unit holders 20 and 21 for holding the roll paper unit 19.

===Internal Configuration of the Printer 2===

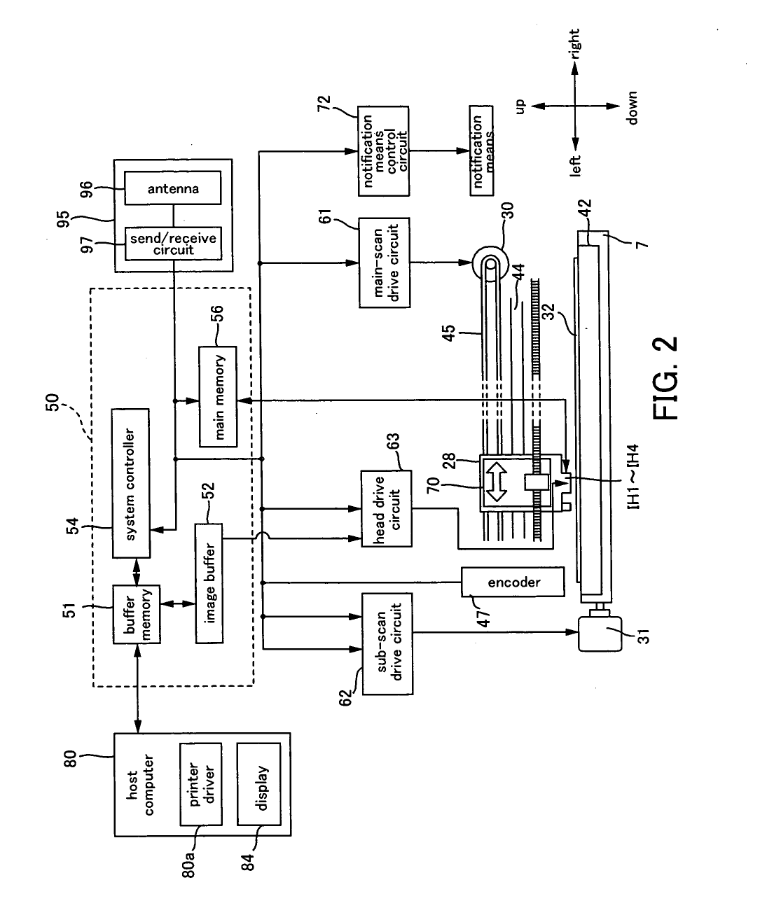

Next, the internal configuration of the printer 2 and the internal configuration of a control circuit 50 are described with reference to FIG. 2. FIG. 2 is a diagram showing the internal configuration of the printer 2 and the internal configuration of the control circuit 50 according to this embodiment.

As shown in the diagram, the printer 2 has a mechanism for ejecting ink and forming dots by driving print heads 22, 24, 25, and 26, which are provided in/on a carriage 28, a mechanism for carrying a print paper 32, such as roll paper, supplied from the paper supply section 13 by a paper feed motor 31, a mechanism for moving the carriage 28 back and forth in the main-scanning direction, which is perpendicular to the direction in which the print paper 32 is carried, using a carriage motor 30, and the control circuit 50.

The mechanism for moving the carriage 28 back and forth is made of a slide shaft 44 that is provided extended in the main-scanning direction and that slidably holds the carriage 28, and a pulley, for example, between which and the carriage motor 30 an endless drive belt 45 is extended.

The mechanism for carrying the print paper 32 that is supplied from the paper supply section 13 has the paper feed motor 31, which is for carrying the print paper between these print heads 22, 24, 25, and 26 and a platen 42 that is in opposition to the print heads, a carry roller 7 that is rotated by the paper feed motor 31, and an encoder 47 for detecting the amount that the print paper 32 has been carried.

The control circuit 50 suitably controls the operations of the paper feed motor 31, the carriage motor 30, and the print heads 22, 24, 25, and 26 when a print command signal is received from the control panel 11 of the printer or from the host computer 80 connected to the printer. The print paper 32 that is supplied from the paper supply section 13 of the printer 2 is guided over the platen 42 and carried by the carry roller 7.

To the carriage 28 are fastened the print heads 22, 24, 25, and 26, each of which being provided with numerous nozzles, and a cartridge mounting section provided in a single unit with the print heads 22, 24, 25, and 26. In the cartridge mounting section are mounted ink cartridges 70 (70C, 70M, 70Y, 70K) that are respectively provided for the each of the colors. The ink cartridges 70 (70C, 70M, 70Y, 70K) accommodate four colors of ink, these being cyan (C), magenta (M), yellow (Y), and black (K), respectively. As mentioned previously, it is also possible for the ink cartridges 70 to accommodate light cyan (LC), light magenta (LM), and dark yellow (DK).

===Internal Structure of the Control Circuit 50===

As shown in FIG. 2, the control circuit 50 is internally provided with a buffer memory 51 for receiving signals that are supplied from the host computer 80, which is provided with the display 84 as a display means, an image buffer 52 for storing print data, a system controller 54 for controlling the overall operations of the printer 2, and a main memory 56. The system controller 54 is further connected to a main-scan drive circuit 61 for driving the carriage motor 30, a sub-scan drive circuit 62 for driving the paper feed motor 31, and a head drive circuit 63 for driving the print heads 22, 224, 25, and 26. Also, the control circuit 50 is connected to a send/receive section 95, which has a send/receive circuit 97 and an antenna 96, for communicating with the memory card 9 that is mounted in the slot 14 provided in the upper portion of the printer 2.

Print data that have been transferred from the host computer 80 are temporarily held in the buffer memory 51. Within the printer 2, the system controller 54 reads necessary information from the print data in the buffer memory 51, and based on this information, sends control signals to the main-scan drive circuit 61, the sub-scan drive circuit 62, and the head drive circuit 63.

Print data for a plurality of color components that have been received at the buffer memory 51 are stored in the image buffer 52. The head drive circuit 63 reads print data for each of the color components from the image buffer 52 according to control signals from the system controller 54, and in accordance with these data, drives the nozzle arrays that are provided in the print heads 22, 24, 25, and 26 and arranged in the sub-scanning direction in rows for each color of ink.

===Configuration of the Memory Card===

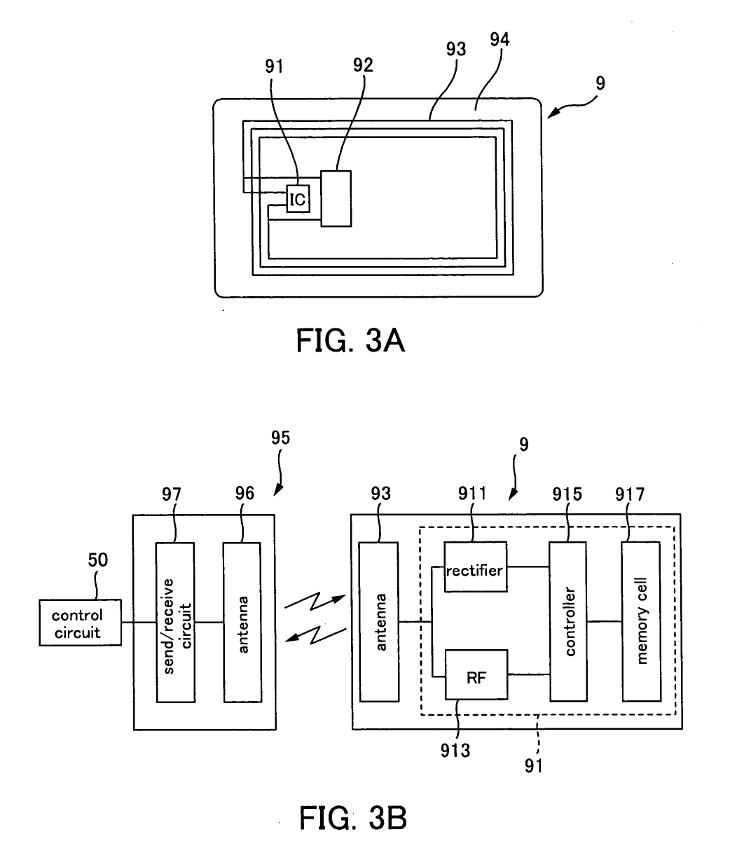

Next, with reference to FIG. 3A and FIG. 3B, the internal configuration of the memory card 9 and the internal configuration of the send/receive section 95 that is provided in the printer 2 will be described. FIG. 3A is a plan perspective view showing the configuration of the memory card 9, and FIG. 3B is a block diagram for describing the internal configuration of the memory card 9 and the send/receive section 95.

The memory card 9 has an IC chip 91, a capacitor 92, an antenna 93, and a film 94. The configuration of the IC chip 91 will be discussed later. The capacitor 92 is a resonance capacitor that is formed by etching a metallic film. The antenna 93 is constituted by a flat coil. The film 94 covers the IC chip 91, the capacitor 92, and the antenna 93, and is constituted by an insulating plastic film.

The IC chip 91 has a rectifier 911, a signal analysis section RF (radio frequency) 913, a controller 915, and a memory cell 917. The rectifier serves as a direct current power source that rectifies the high-frequency magnetic field captured by the antenna 93 to drive the circuits within the IC chip 91. The memory cell 917 is a non-volatile memory, such as a NAND-type flash ROM, that can be read and written electrically. The memory cell 917 can store information that has been written, and information stored therein can be read from the outside.

The memory cell 917 stores process information for executing various processes with respect to the original image data to be printed. Here, ‘various processes’ means processes for altering the color tone, such as emphasizing a specific color contained in the original image or converting a color image into a monochrome image or a sepia image, and also processes for altering the size and the resolution of the image to be printed. Examples of the process information for these processes include: as the process information for altering the color tone, a color conversion data table that is referred to when creating print data to print an image with an altered color tone; and as the information for altering the image size and resolution, information necessary for processing to decimate or interpolate the data amount in order to create suitable print data from the original image data.

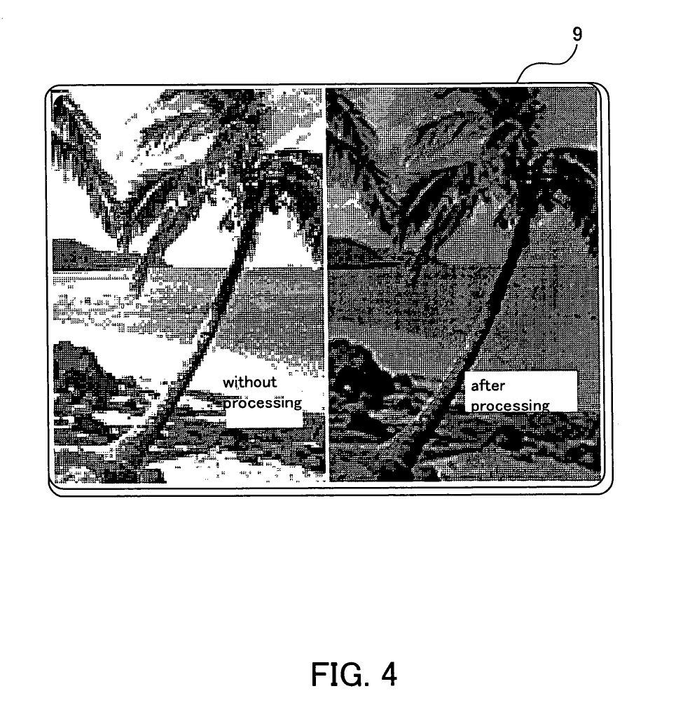

FIG. 4 is an external view showing an example of the external appearance of the memory card. As shown in the diagram, in order to allow visual confirmation of the change in the image when it is printed using the process information stored in the memory card 9, an example of an image printed without using the memory card 9, that is, without carrying out the processing, and an example of an image printed using the memory card 9, in which processing has been carried out, are shown side by side on the surface of the memory card 9. For example, if a color conversion data table for emphasizing the color red is stored in the memory card 9, then on the left half of the memory card 9, an original image is printed accompanying an indication that the image has not been processed, and on the right half of the memory card 9, an image in which the color red has been emphasized using the stored color conversion data table is printed, accompanying an indication that the image has been processed. The images can be provided on the surface of the memory card 9 by printing them directly onto the memory card 9 or by attaching thereto a label on which the images are printed. Also, the display showing the change in the image processed using the memory card 9 is not limited to images, and may also be achieved by writing the words “red color emphasis card” or “sepia image card,” for example, and indications such as “+1”, “+2”, “−1”, and “−2” corresponding to the level of color tone alteration may also be added.

On the other hand, the send/receive section 95 provided in the printer 2 has the antenna 96 and the send/receive circuit 97, as shown in FIG. 3. The antenna 96 functions as a communications means for communicating with the memory card 9. The antenna 96 also serves as a reader (reading means) for reading information stored in the memory card 9. The antenna 96 is covered with an insulating plastic film (not shown) in the same manner as the antenna 93 of the memory card 9. The send/receive circuit 97 generates high-frequency signals and induces a high-frequency electromagnetic field via the antenna 96 so as to wirelessly communicate with the memory card 9. The send/receive circuit 97 is connected to and controlled by the control circuit 50. The control circuit 50 also functions as a processor (processing means) for performing predetermined processing with respect to image data based on the information that is read from the memory card 9 by the reader.

In this embodiment, communication between the antenna 96 provided in the printer 2 and the memory card 9 is carried out wirelessly, thus permitting non-contact communication between the two. Consequently, compared to a case in which a contact-type connector is used, there is improved durability because the lack of contact points eliminates friction, and handling becomes simple because precise positioning is not necessary.

===Card Slot===

The slot 14 constitutes an attachment section to and from which the memory card 9, which is an external storage medium, can be attached and removed, and as shown in FIG. 1, it is provided in an upper portion of the printer 2. The slot 14 has a card insert opening 14a provided with a hollow section, and when the memory card 9 is inserted through the card insert opening 14a, the inner walls of the slot 14 control the position of the memory card 9. It should be noted that when the memory card 9 is inserted into the slot 14, it is possible for the lamp 112 to blink or for the color of the lamp 112 to change. Also, when the memory card 9 inserted into the slot 14 is not properly inserted, it is possible for the user to be notified of this through a change in the lamp 112.

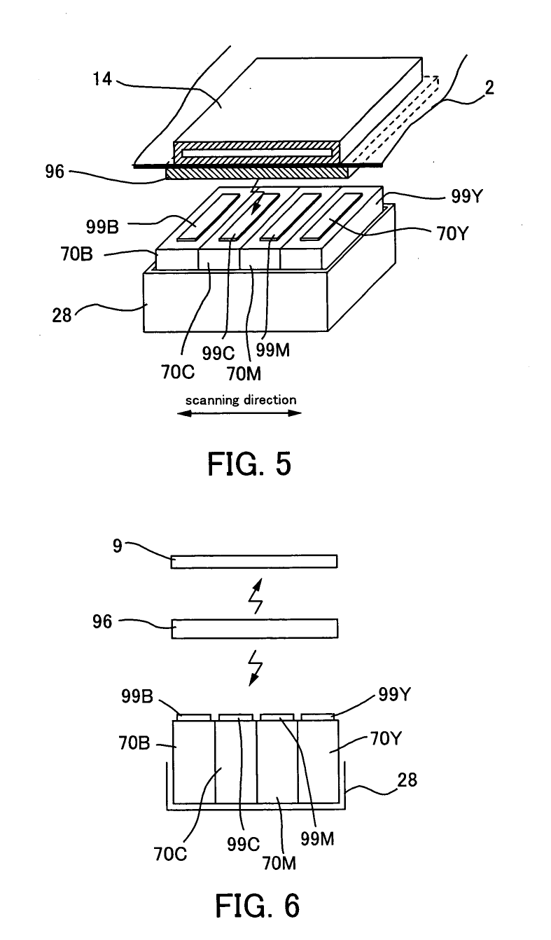

FIG. 5 is an explanatory diagram showing the positional relationship between the slot 14 of the printer 2 of this embodiment and the antenna 96. In this diagram, structural elements that have been described already are assigned identical reference numerals and description thereof is omitted.

In this embodiment, a particular example is shown in which the cartridges 70 (70B, 70C, 70M, 70Y) are also configured having storage units 99 (99B, 99C, 99M, and 99Y, respectively), and each storage unit 99 stores information pertaining to its cartridge and can communicate wirelessly through the antenna 96. The configuration of the storage units 99 is substantially the same as the above-described memory card 9.

More specifically, the slot 14 is provided in a position where it can communicate wirelessly with both the memory card 9 in the slot 14 and the storage units 99 of the cartridges 70. Thus, one surface of the antenna 96, which is formed flat, of the send/receive section 95 is in opposition to the storage units 99, and its other surface is in opposition to the memory card 9 that is inserted into the slot 14. Also, by utilizing the ability of the antenna 96 to generate magnetic fields at both surfaces, the same antenna 96 can serve as both the antenna for wirelessly communicating with the memory card 9 inserted into the slot 14 and the antenna for wirelessly communicating with the storage units 99 provided in/on the cartridges 70. Thus, a low-cost printer requiring less space can be achieved.

===Communication Operation===

FIG. 6 shows a state in which the antenna 96 can communicate with both the memory card 9 and the cartridges 70. In this state, the memory card 9 is mounted in the slot 14, and the carriage 28 is stopped at a position where the antenna 96 can communicate with the storage units 99. In other words, the carriage 28 is positioned so that the storage units 99 are in opposition to the lower surface of the antenna 96, and the antenna 96 is positioned between the storage units 99 and the slot 14 (that is, the memory card 9). In this state, when the antenna 96 generates a magnetic field in order to communicate wirelessly, it can communicate with both the storage units 99 and the memory card 9 at the same time.

In the state of FIG. 6, if the antenna 96 tries to communicate with the storage units 99, a magnetic field is generated on the memory card 9 side as well, and thus collision of signals becomes a problem. Accordingly, when performing communication in this state, an identifier (for example, ID information) is included in the signal to be communicated so as to avoid signal collision. It should be noted that including an identifier in the communication signal allows the antenna 96 to communicate with a given storage unit 99, even if there are a plurality of storage units 99 with which the antenna 96 can communicate.

===Printing Operation===

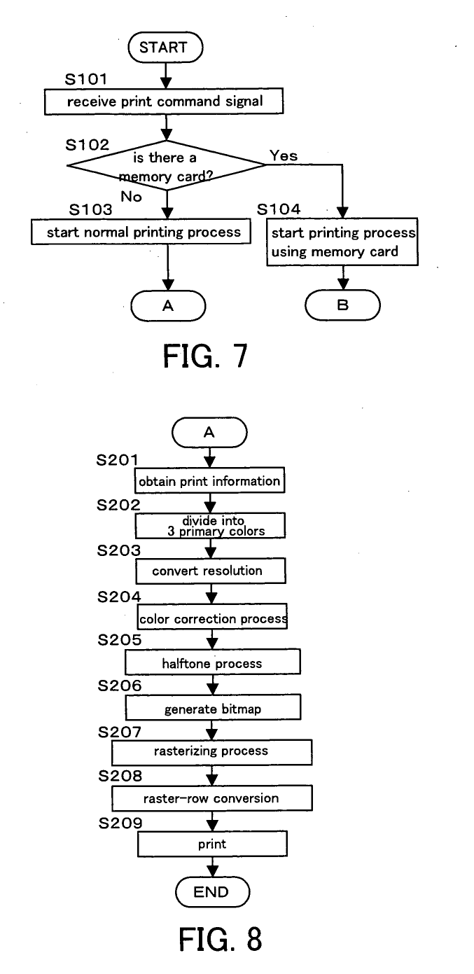

FIG. 7 is a diagram for describing the concept of the printing operation of the present invention.

The computer system 1 serving as the printing apparatus is run based on print commands input from the host computer 80 by the user. When a print command is input (S101), the control circuit 50 of the printer 2 tries to communicate with the memory card 9 via the send/receive section 95 (S102). At this time, if it is not possible to communicate with the memory card 9, that is, if the memory card 9 is not mounted in the slot 14, then normal printing is performed (S103), and if communication with the memory card 9 is possible, then a print operation using the process information stored in the memory card 9 is performed (S104).

<<<Printing Process When Memory Card is Not Used>>>

FIG. 8 is a flowchart showing an overview of the normal printing process of the computer system according to this embodiment.

When image data to be printed are designated by the user and a print command is received along with print information from the host computer 80 (S101), the print information is read by the printer driver 80a within the host computer 80. Print information includes, for example, the type of print paper, such as glossy paper or plain paper, and the print mode, such as fine mode or quick mode, designated by the user. By designating the type of print paper and the print mode, the resolution in the main-scanning and sub-scanning directions of the image to be printed and the printing modes, such as a band feed mode and various types of interlace modes, are determined. For example, if the user designates plain paper and designates quick mode as the print mode, then an image with a resolution of 360 dpi in both the main-scanning and sub-scanning directions is printed in the band feed mode, and if glossy paper and fine mode are designated, then an image with a resolution of 1440 dpi in the main-scanning direction and a resolution of 720 dpi in the sub-scanning direction is printed with a predetermined interlace mode.

When print information is obtained from the received print information (S201), designated image data are supplied to the printer driver 80a, and the normal printing operation is carried out. That is, designated image data (image signals that have been read) are given to the printer driver 80a and separated into the three primary colors R (red), G (green), and B (blue) by the rasterizer provided in the printer driver 80a, obtaining RGB bitmap data that have been raster converted for each color (S202). The RGB bitmap data that are obtained are converted so that the resolution corresponds to the output resolution of the printer (S203). Then, in order to make the data correspond to the print colors, the resolution-converted RGB bitmap data are subjected to color correction by referring to a color conversion data table using a color correction module, and are converted into CMYK bitmap data for printing in K (black), C (cyan), M (magenta), and Y (yellow) (S204). Then, cyan C and magenta M of the CMYK bitmap data are separated into cyan C and light cyan LC, and magenta M and light magenta LM, respectively, in accordance with a dark-light ink separation table, and then halftone processing such as dithering or error diffusion is executed by a halftone module (S205). Thus, for example, the arrangement on the bitmap is set for each color, and binary bitmap data are created for each color (S206).

The binary bitmap data are sent to the printer 2 along with control signals. In the printer 2, the binary bitmap data are stored in the buffer memory 51, and according to processing by the system controller 54, they are subjected to a rasterizing process and raster-row conversion in order to correspond to the designated print mode and then loaded into the image buffer (S207, S208). The system controller 54 then controls the main-scan drive circuit 61, the sub-scan drive circuit 62, and the head drive circuit 63 based on the control signals of the host computer, and makes the heads for each color eject dots of a predetermined type based on the data in the image buffer (S209).

<<<Printing Process Using the Memory Card>>>

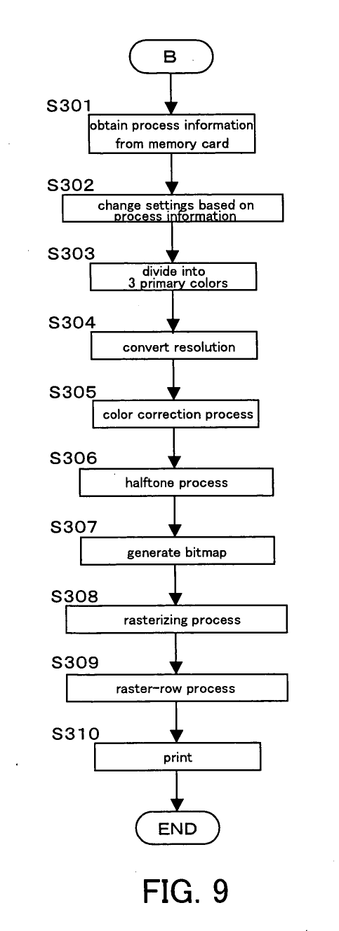

FIG. 9 is a flowchart showing an overview of the printing process of the computer system according to this embodiment when the memory card is used. Some of the operations that are common to both this print operation and the normal print operation described above are omitted from the following description. In this embodiment, a color conversion data table used to emphasize the color red is stored in the memory card 9 as the process information.

Normally, the color conversion data table is a table for converting RGB image signals to CMYK output color data. For example, all the colors of RGB image signals are arranged in a La*b* space (hereinafter, referred to as “Lab space”) defined by the CIE (International Commission on Illumination), and the table correlates the arrangement of the colors in the Lab space and the ratio of cyan, magenta, yellow, and black mixed to express those colors in CMYK. For example, if the L axis, a axis, and b axis of the Lab space are each shown as 8-bit data (0 to 255), then the color red, which is expressed by a R signal of ‘255’, a G signal of ‘0’, and a B signal of ‘0’, is arranged in the Lab space as ‘58’ on the L axis, ‘97’ on the a axis, and ‘95’ on the b axis, and the ratio of cyan, magenta, yellow, and black that are mixed to express this color red is 100% for magenta and yellow only and 0% for cyan and black.

In contrast to the color conversion data table used in the normal printing process described above, the color conversion data table used in the process for emphasizing the color red that is stored in the memory card 9 is set so that only the values of magenta and yellow are increased by, for example, 10%. Thus, for example, an orange-red color expressed by a R signal of ‘217’, a G signal of ‘109’, and a B signal of ‘18’ is expressed as cyan 0%, magenta 87%, yellow 82%, and black 0% in a normal color conversion data table; however, when the color conversion data table that is stored in the memory card 9 is referred to, it is expressed as cyan 0%, magenta 97%, yellow 92%, and black 0%, and therefore the color red is emphasized in the printed image.

When the image data are designated and a print command is received (S101), the system controller 54 of the printer 2 communicates with the memory card 9 via the send/receive section 95 and reads the color conversion data table stored in the memory cell 917 (S301). The color conversion data table that is read is supplied to the printer driver 80a, and settings are made so that the color conversion data table that has been supplied is referred to when printing the image data that were designated along with the print command (S302). Also, the resolution in the main-scanning direction and the sub-scanning direction, as well as the print mode, such as the band feed mode or various types of interlace modes, are determined based on the print information that are received by the printer driver 80a.

When settings are made based on the process information that is obtained, the designated image data are supplied to the printer driver 80a and separated into the three primary colors R (red), G (green), and B (blue) by the rasterizer, obtaining RGB bitmap data that have been raster converted for each color (S303). The RGB bitmap data that are obtained are converted to correspond to the output resolution (S304), subjected to color correction by the color correction module with reference to the color conversion data table read from the memory card 9 (S305), and converted into CMYK bitmap data for printing. At this time, the process for emphasizing the color red is performed on the image data.

Then, the CMYK bitmap data are subjected to halftone processing after being separated into dark and light ink (S306), generating binary bitmap data (S307), and these data are transmitted to the printer 2 together with control signals. In the printer 2, the binary bitmap data are stored in the buffer memory 51, and through processing by the system controller 54, they are subjected to a rasterizing process and raster-row conversion in order to correspond to the designated print mode and then loaded into the image buffer (S308, S309). The system controller 54 then controls the main-scan drive circuit 61, the sub-scan drive circuit 62, and the head drive circuit 63 based on the control signals of the host computer to make the heads for each color eject dots of a predetermined type based on the data of the image buffer (s310).

<<<Modified Example of Process Information Stored in Memory Card>>>

In the above embodiment, a color conversion data table for emphasizing the color red was described. However, a color conversion data table for emphasizing other colors is also possible.

A color conversion data table for converting color image data to a monochrome image and a color conversion data table for conversion to a sepia-tone image or a cool-tone image are also possible. A color conversion table for converting to a monochrome image correlates the various colors arranged in the Lab space and the values where the color saturation of those colors is set to ‘0’. That is, in Lab space, output data corresponding to every color are arranged on the L-axis and are expressed by achromatic gradation.

Sepia-tone images are expressed by mixing magenta-based or yellow-based dots among dots of achromatic ink, and cool-tone images are expressed by mixing magenta-based or cyan-based dots among dots of achromatic ink. Therefore, a color conversion data table for conversion to sepia-tone or cool-tone images is a color conversion data table in which the ratio of cyan, magenta, and yellow in a color conversion table for conversion to monochrome images has been slightly increased. The process information for changing these color tones is not limited to a color conversion data table, and it is also possible to store a coefficient or a program for creating a new color conversion data table by changing the values of the normal color conversion data table of the printer driver.

Also, as the process information for changing the image size, if the size of the image to be output is to be half the size of the original image in both the main-scanning direction and the sub-scanning direction, then process information for incorporating the image data every other pixel in the main-scanning direction and every other raster line in the sub-scanning direction, or for synthesizing adjacent pixel data to create data for a single pixel, is stored.

As the process information for converting the resolution of the image to be output, if the resolution of the image to be output is half the resolution of the original image in both the main-scanning direction and the sub-scanning direction, then process information for synthesizing the data of two adjacent pixels in the main-scanning direction and the sub-scanning direction of the image data into data for a single pixel is stored.

===Other Embodiments===

In the foregoing, a printing apparatus, for example, according to the invention was described based on an embodiment thereof. However, the foregoing embodiment is for the purpose of elucidating the present invention and is not to be interpreted as limiting the present invention. The invention can of course be altered and improved without departing from the gist thereof and includes functional equivalents.

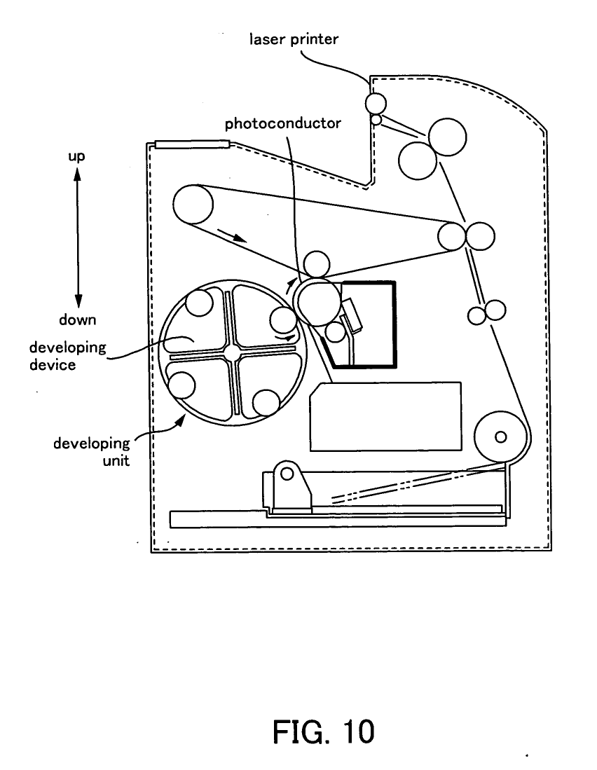

Also, in present embodiment an example was shown in which an inkjet printer was used as the printer. However, it is also possible to use a laser printer such as the one shown in FIG. 10, for example.

It should be noted that in the foregoing description, an example was shown in which the printer 2 was connected to the host computer 80 to form a computer system serving as the printing apparatus; however, this is not a limitation. For example, the printer 2 may be a single unit if it is of a configuration that allows designated image data to be converted to CMYK bitmap data that serves as print data. In this case, the printer 2 may also include a display section for carrying out various displays, and a recording media attachment/detachment section to and from which recording media storing image data captured by a digital camera or the like are inserted and taken out.

<<<Regarding the Configuration of the Slot>>>

In the foregoing embodiment, the slot 14 into which the memory card 9 can be inserted was provided in an upper portion. However, the structure to and from which the memory card 9 is attached and detached is not limited to a slot.

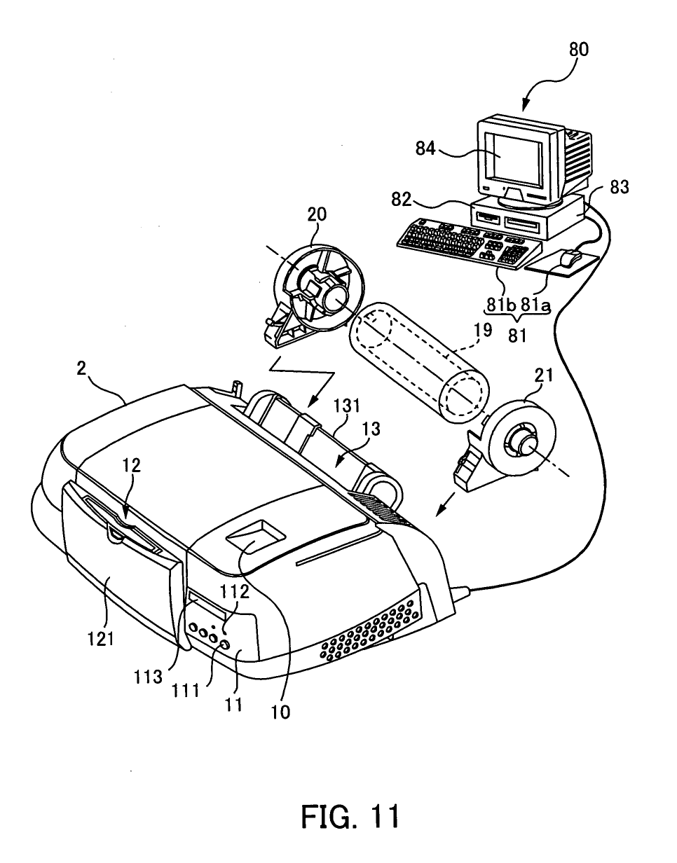

FIG. 11 is a schematic external view of a printer according to another embodiment. In this diagram, structural elements that are the same as those of the foregoing embodiment are assigned identical reference numerals and description thereof is omitted. The printer 2 of this embodiment is provided with a mount tray 10 that serves as the section to and from which the memory card 9 is attached and detached, in place of the slot of the above embodiment.

The mount tray 10 is a recession provided in the upper portion of the cover, and serves as a mount section on which the memory card 9 is simply placed in such a manner that is does slide off. The size of the mount tray 10 is substantially the same as that of the memory card 9 or is set slightly larger than the memory card 9, so that the spot where the memory card 9 is placed is stable. As a result, when the memory card 9 is placed on the printer 1 it can be positioned on the rear side of the antenna (not shown), allowing wireless communication between the antenna and the memory card 9.

That is, the section to and from which the memory card 9 is attached and detached may be embodied by other means, as long as it is capable of positioning the memory card 9 in a position where the antenna can wirelessly communicate with it.

<<<Regarding the Memory Card>>>

In the above embodiment, the memory card 9 carried out communication in a wireless fashion. However, communication with the memory card 9 is not limited to this.

For example, contact-type communication may also be used to communicate with the memory card. In this case, the printer has a connecter that serves as a communication means for connecting to the memory card, and the memory card has a contact point for connecting to the connector.

It is preferable that the memory card has a marking for identifying the direction of the memory card. It should be noted that this marking is such that allows identification of the direction of the memory card either visually or through touch, and is for example a character, symbol, or notch. In this way, the memory card can be mounted in the correct direction, so that the memory card is properly connected to the connector.

With the memory card shown in FIG. 4, in order to visually confirm the change in the image when printed using the process information stored in the memory card 9, an example of an image printed without using the memory card 9, that is, without being processed, and an example of an image printed using the memory card 9, that is, after being processed, are shown side by side on the surface of the memory card 9. However, these image examples do not necessarily have to be shown on the surface of the memory card 9.

For example, an example of an image printed without using the memory card 9, that is, without being processed, and an example of an image printed using the memory card 9, that is, after being processed, can be stored in the memory card 9 as image data. Then, when the memory card 9 is mounted in the slot 14 (see FIG. 1) the image data are read, and the example of the image printed without using the memory card 9 and the example of the image printed using the memory card 9 can be displayed on the display 84 of the host computer 80 (see FIG. 1) or the display 113 provided in the printer 2 (see FIG. 1).

If such a modified example is adopted, then, for example, when a color conversion data table for emphasizing the color red is stored in the memory card 9, the original image that has not been processed and the image in which the color red has been emphasized using the stored color conversion data table are displayed on the display 84, for example, when the memory card 9 is mounted in the slot 14 (see FIG. 1).

<<<Regarding the Antenna>>>

In the foregoing embodiment, the antenna communicated with both the storage units 99 and the memory card 9. However, it is not absolutely necessary that the antenna be shared, and may be embodied differently. For example, it is possible to independently provide an antenna for communicating with the storage units 99 and an antenna for communicating with the memory card 9.

With the above-described embodiment, a storage medium with which printing can be carried out easily by performing desired processing with respect to image data and which allows changes in the image due to processing to be visually confirmed in advance before operations, a printing method using such a storage medium, and a printing apparatus suited for printing using such a storage medium can be achieved.

1. A storage medium that is used for performing predetermined processing with respect to image data for printing with a printing apparatus, and that is provided independent of said printing apparatus, comprising:
process information for performing said predetermined processing; and
information for allowing visual confirmation of a change in an image that is caused by said processing.

2. A storage medium according to claim 1,
wherein said information for allowing visual confirmation is shown on a surface of said storage medium.

3. A storage medium according to claim 1,
wherein said process information is information for making a change in a color tone of an image to be printed.

4. A storage medium according to claim 3,
wherein said change in the color tone is an emphasis of a specific color.

5. A storage medium according to claim 3,
wherein said change in the color tone is a color conversion from a color image to a monochrome image.

6. A storage medium according to claim 3,
wherein said change in the color tone is a color conversion from a color image to a sepia image.

7. A storage medium according to claim 3,
wherein said information for making a change in the color tone is a color conversion data table.

8. A storage medium according to claim 1,
wherein said process information is information for changing a size of an image to be printed.

9. A storage medium according to claim 1,
wherein said process information is information for changing a resolution of an image to be printed.

10. A storage medium according to claim 1,
wherein said information for allowing visual confirmation is an example of an image printed without said processing being performed and an example of an image printed with said processing being performed.

11. A storage medium according to claim 1,
wherein said storage medium is capable of communicating wirelessly with said printing apparatus.

12. A storage medium according to claim 1,
further comprising a flat antenna.

13. A storage medium according to claim 1,
further comprising a contact point for connecting to said printing apparatus.

14. A storage medium that is used for performing predetermined processing with respect to image data for printing with a printing apparatus, and that is provided independent of said printing apparatus, comprising:
a color conversion data table for changing a color tone of an image to be printed in order to perform said processing;
information for allowing visual confirmation of a change in an image that is caused by said processing, wherein said information is an example of an image printed without said processing being performed and an example of an image printed with said processing being performed that are shown on a surface of said storage medium; and
a flat antenna that is capable of communicating wirelessly with said printing apparatus.

15. A printing method for performing predetermined processing with respect to image data for printing with a printing apparatus, comprising the following steps:
a step of setting, on said printing apparatus, a storage medium which is provided independent of said printing apparatus and in which process information for performing said predetermined processing is stored, and which has information for allowing visual confirmation of a change in an image that is caused by said predetermined processing;
a step of obtaining said process information;
a step of performing said predetermined processing with respect to said image data based on said process information that has been obtained; and
a step of printing based on the image data that has been subjected to said predetermined processing.

16. A printing apparatus capable of performing predetermined processing with respect to image data for printing, comprising:
a reader for reading information in a storage medium which is provided independent of said printing apparatus and in which process information for performing said predetermined processing is stored, and which has information for allowing visual confirmation of a change in an image that is caused by said predetermined processing; and
a processor for performing said predetermined processing based on said information that has been read out.
